(19) United States
(12) Patent Application Publication
(10) Pub. No.: US 2006/0283979 A1
(43) Pub. Date: Dec. 21, 2006

(54) Homogenising nozzle and process for the production of an aqueous two-component polyurethane coating emulsion

(75) Inventors: Bernd Klinksiek, Bergisch Gladbach (DE); Lars Obendorf, Koln (DE); Nusret Yuva, Burscheid (DE); Markus Mechtel, Bergisch Gladbach (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/452,562

(22) Filed: Jun. 14, 2006

(30) Foreign Application Priority Data
Jun. 18, 2005 (DE) 102005028291.1

(51) Int. Cl. F23D 11/10; B05B 1/30

(52) U.S. Cl. 239/421; 239/545; 239/583

(57) ABSTRACT

The invention describes a homogenising nozzle 100 comprising a casing 10, a piston 11 arranged displaceably along the longitudinal axis of the casing 10, a first inlet 14 for a first component, a second inlet 15 for a second component and an outlet 16 for a homogenised mixture of the first and second components, wherein the first inlet 14 and the outlet 16 are arranged along the longitudinal axis of the casing 10 in such a manner that, by displacing the piston 11, the free cross-section of the first inlet 14 and the free cross-section of the outlet 16 may be varied. A process is furthermore described for the production of an aqueous two-component polyurethane coating emulsion by mixing at least one aqueous binder dispersion comprising isocyanate-reactive groups and a polyisocyanate using the described homogenising nozzle.

### CROSS-REFERENCE TO RELATED APPLICATION

This application claims priority under 35 U.S.C. §119 (a)-(e) to German application DE 10 2005 02829.1, filed Jun. 18, 2005.

### FIELD OF THE INVENTION

The invention relates to a homogenising nozzle and to a process for the production of an aqueous two-component polyurethane coating emulsion using the homogenising nozzle.

### BACKGROUND OF THE INVENTION

EP-B 0 685 544 discloses a process for the production aqueous two-component polyurethane coating emulsions based on binder resins comprising isocyanate-reactive hydrogen atoms and polyisocyanates by mixing the components with water. In continuous operation, a polyol/water dispersion on the one hand and a polyisocyanate on the other are supplied to a jet disperser for dispersion. Homogenisation pressures of approx. 5 MPa are required in order to obtain a finely divided emulsion of the polyisocyanate with a particle size of approx. 0.5 μm in the aqueous polyol emulsion with a particle size of approx. 0.2 μm. The isocyanate particles are stabilised by the ionically-modified polyol particles. No emulsifier is necessary.

An adjustable jet disperser for the production of aqueous two-component polyurethane (PU) emulsions is furthermore known from WO 01/05860 or WO 01/05517. The coating emulsion is produced on the basis of aqueous binder dispersions comprising isocyanate-reactive groups and polyisocyanates by mixing the two components at a pressure of 1 to 30 MPa in an adjustable jet disperser with openable or closable nozzle bores or slots. In said process, a pre-emulsion is initially produced at a relatively low pressure of, for example, 0.1 MPa. Homogenisation then proceeds in an adjustable jet disperser at a pressure of 1 to 30 MPa. Either a certain number of bores or a certain slot length are opened by adjusting the feedback-controlled control piston with a pneumatic cylinder. In this manner, constantly good dispersion quality is achieved with a continuously variable throughput of material to be dispersed. The disadvantage of the jet disperser or production process known from WO 01/05860 or WO 01/05517 is that a separate apparatus is required for forming the pre-emulsion. This separate apparatus is moreover not adjustable, such that the quality of the pre-emulsion varies in the case of variable throughput, and thus variable pressure.

The dispersing nozzle known from EP 685 544 A, in particular from FIG. 4, likewise has the disadvantage that a separate apparatus is required for forming the pre-emulsion. If the dispersing nozzle known from EP 685 544 A is used for the production of coatings, a comparatively elevated pressure of more than 50 bar is required.

A process is known from WO 04/76515 in which finely divided dispersions are obtained at pressures of below 25 bar. Here too, a two-component coating mixture is produce in a mixer, which mixture is then homogenised in a homogeniser. A return line branches off in the output zone of the homogeniser, which line opens into the input zone of the homogeniser, in order to subject a proportion of the coating mixture homogenised by the homogeniser to rehomogenisation. It is thus necessary to operate a pump as a recirculation conveying unit which is connected with mixed, reactive material. Apart from the additional conveying unit for recirculation stream, a further disadvantage of the process is that a pre-emulsion must be produced, the quality of which is moreover subject to fluctuation.

### SUMMARY OF THE INVENTION

The object of the present invention is to provide a homogenising nozzle which is of the simplest possible construction and produces finely divided emulsions or suspensions at the lowest possible pressures. The homogenising nozzle is intended to combine two starting streams directly without there being any need to produce a pre-emulsion in a separate apparatus. At the same time, it is intended either that a constant pressure is ensured at variable flow rates or, alternatively, that the pressure is freely selectable at a constant flow rate.

A further object is to provide a process for the production of an aqueous two-component polyurethane coating emulsion by mixing at least one aqueous binder dispersion comprising isocyanate-reactive groups and a polyisocyanate, which process yields a finely divided coating emulsion without involving the production of a pre-emulsion.

The present invention provides a homogenising nozzle comprising a casing, a piston arranged displaceably along the longitudinal axis of the casing, a first inlet for a first component, a second inlet for a second component and an outlet for a homogenised mixture of the first and second components, wherein the first inlet and the outlet are arranged along the longitudinal axis of the casing in such a manner that, by displacing the piston, the free cross-section of the first inlet and the free cross-section of the outlet may be varied.

### BRIEF DESCRIPTION OF THE DRAWINGS

The invention is illustrated in greater detail below with reference to the attached schematic drawings, in which:

FIG. 1a shows in longitudinal section an embodiment of the homogenising nozzle according to the invention with in each case a slot for the first inlet and the outlet

FIG. 1b shows the homogenising nozzle presented in FIG. 1a in cross-section along the axis A-A of FIG. 1a

FIG. 2a shows in longitudinal section an embodiment of the homogenising nozzle according to the invention with in each case bores arranged in a row for the first inlet and the outlet

FIG. 2b shows the homogenising nozzle presented in FIG. 2a in cross-section along the axis A-A of FIG. 2a

FIG. 3 shows an embodiment as shown in FIG. 2 with an additional flushing bore.

### DETAILED DESCRIPTION OF PREFERRED EMBODIMENTS

The casing of the homogenising nozzle according to the invention is preferably cylindrical, but may in principle be of any desired cross-section. The piston mounted in the casing is accordingly likewise preferably cylindrical. The piston may be moved along the longitudinal axis of the casing. To this end, the piston is mounted at a first end of the casing. The opposite, second end of the casing is hereinafter described as the free end or bottom of the casing. The wall of the casing, along which the piston may be moved, is hereinafter also described as the side wall. The piston comprises mechanical, electrical, hydraulic or pneumatic drive means. Electrical, hydraulic or pneumatic drive means are preferred for very rapid and precise changes in piston position. This is in particular necessary for applications in which throughput is subject to rapid and major variation, such as for example in the case of the rapidly fluctuating intake rates of coating bells in coating lines.

The casing, in particular the internal wall of the casing, and/or the piston preferably consist of ceramics or comprise a ceramic coating. This enables the homogenising nozzle to be produced with very fine tolerances and ensures very easy, virtually leak-free mobility of the piston. Zirconium oxide or SiC is in particular used as the ceramic material. This enables trouble-free processing over an extended period of mixture components (e.g. coating components) also containing abrasive fillers (for example SiO₂ or TiO₂).

The homogenising nozzle according to the invention comprises at least two inlets and one outlet. The first inlet serves to supply a first component or a first component mixture, the second inlet serves to supply a second component or a second component mixture. Hereinafter, for simplicity's sake, the terms first and second component are used, these terms in each case respectively including a first or second component mixture. As the first and second component emerge from the outlet, a homogenised mixture of the two components is formed.

According to the invention, the first inlet and the outlet of the casing are provided in the side wall of the housing along the longitudinal axis. They are arranged such that the free cross-section of the first inlet and the free cross-section of the outlet may be varied by displacement of the piston. The free cross-section is deemed to be that part of the cross-section of the first inlet or of the outlet which is open, i.e. which is not closed by the piston.

The first inlet and/or the outlet may consist of a plurality of bores arranged along the longitudinal axis or of at least one slot arranged along the longitudinal axis. This means that several embodiments is possible. The first inlet may comprise a plurality of bores, while the outlet comprises at least one slot. However, the first inlet may conversely comprise at least one slot, while the outlet may consist of a plurality of bores. It is furthermore possible for bores to be provided both for the first inlet and for the outlet. Finally, at least one slot may in each case be provided both for the first inlet and for the outlet. The embodiments of the first inlet and of the outlet may be selected mutually independently. This relates not only to the shape of the orifice, i.e. bore or slot, but also to the number of bores or slots and other parameters of the orifices, such as the cross-section of the bores, length and width of a slot etc.

The cross-section of the first inlet is preferably 8·10⁻¹¹ to 8·10⁻³ m² and the cross-section of the outlet 8·10⁻¹¹ to 8·10⁻³ m². In the case of bores as the first inlet and/or outlet, the cross-section is deemed to be the total area of the bores. In the case of a slot, the area of the slot, calculated from the length and width of the slot, corresponds to the cross-section. If several slots are provided as the first inlet and/or as the outlet, the cross-section is deemed to be the sum of the slot areas. The bores or slots are positioned such that the free cross-section, i.e. the proportion of the cross-section which is open, depends on the position of the piston.

In the case of bores, the number of open or closed bores varies with the position of the piston. The number of the bores preferably amounts to 1 to 10000 with a preferred diameter of 10 to 1000 μm. The bores may be of any desired cross-section, for example round, oval, polygonal. The bores are arranged in rows along the longitudinal axis of the casing. The bores may here be spaced regularly or irregularly from one another. If two or more rows of bores are provided along the longitudinal axis of the casing, the bores of the different rows may be staggered relative to one another along the longitudinal axis. If more than one row of bores is present, the bores of different rows are preferably staggered relative to one another along the longitudinal axis such that the free cross-section may be virtually continuously varied. In a preferred embodiment, one row of bores is provided.

In the case of slots, the length of slot which is open or closed is varied by displacement of the piston. The total length of a slot preferably amounts to 1 to 50 mm, particularly preferably to 5 to 15 mm. The width of a slot is preferably 10 to 1500 μm, particularly preferably 50 to 400 μm. A slot may also be of a shape other than rectangular, for example a trapezoidal shape, such that the width of the slot varies over the overall length of the slot, i.e. along the longitudinal axis of the casing. The number of slots amounts to 1 to 250, particularly preferably to 1 to 5.

The depth of the bores or the slot is selected such that it amounts to 0.5 times to 20 times the width, preferably to once to 10 times, particularly preferably to 1.5 times to 5 times the width. Depth is defined as the wall thickness (i.e. the thickness of the casing wall) in the region of the bores or slots. The casing wall may be thinner in the region of the bores or slits than the casing wall in the other regions of the side wall. This is achieved, for example, by milling away the casing wall around the region of the bores or slots. Width should be taken to mean the diameter of the bores in the case of bores and the width of the slots in the case of slots.

In a preferred embodiment, the first inlet and the outlet are arranged substantially diametrically opposite to one another in the side wall of the casing. Other locations are possible. The second inlet and the outlet may accordingly be arranged substantially perpendicular to one another or alternatively at any desired angle to one another. The first inlet and the outlet may be arranged staggered relative to one another along the longitudinal axis of the casing, such that when the piston is retracted either the first inlet is opened first and then the outlet, or the outlet is opened first and then the first inlet. It is, however, also possible to select an unstaggered arrangement of the first inlet and the outlet along the longitudinal axis of the casing.

The second inlet for a second component is arranged in the region of the free end of the casing. The second inlet may be arranged such that it is open irrespective of the position of the piston along the longitudinal axis of the casing. This is the case if the second inlet is arranged in the bottom of the casing. The second inlet may, however, also be arranged such that it is opened or closed by displacement of the piston along the longitudinal axis of the casing. In this embodiment, the second inlet is arranged in the side wall in the region of the free end. If the second inlet is provided in the side wall of the casing, it is arranged such that, when the piston is retracted, the second inlet is opened before the first inlet and the outlet are opened.

The second inlet may be an individual bore of any desired cross-section, for example round. It may, however, also consist of two or more bores. In particular, an orifice with a diameter of 0.5 to 10 mm, particularly preferably of 3 to 6 mm serves as the second inlet.

The homogenising nozzle is preferably provided with an arrangement for flushing the piston. A flushing bore is for example arranged for this purpose in the side wall in the region of the casing in which the piston is mounted. A flushing chamber may be connected to the homogenising nozzle via the flushing bore. The flushing chamber may be filled with a flushing fluid, for example an aqueous solution containing alcohol and/or a solvent. When the piston is retracted, the first inlet and the outlet are firstly opened and, as retraction continues, so too is the flushing bore, such that flushing fluid can flow into the homogenising nozzle.

The homogenising nozzle according to the invention enables the production of finely divided emulsions in a single homogenising nozzle. In order to obtain finely divided emulsions using the homogenising nozzle according to the invention, there is no need to produce a pre-emulsion in an upstream mixing device, for example a second nozzle. In the homogenising nozzle according to the invention, the phase to be dispersed is first broken up on introduction into the homogenising nozzle. The mixture is further broken up as it emerges from the homogenising nozzle. A further advantage resides in the adjustability of the homogenising nozzle. In the case of slots or an appropriately staggered arrangement of bores, the flow rate can be continuously varied by displacing the piston. The homogenising nozzle furthermore makes it possible to control dispersion pressure at a constant flow rate. Alternatively, the homogenising nozzle enables a constant dispersion pressure, and thus constant dispersion quality, at a variable throughput.

Using the homogenising nozzle according to the invention, emulsion quantities substantially identical to those of the prior art are obtained at distinctly lower pressures than known in the prior art. Emulsion quality may, for example, be evaluated with reference to particle size.

The homogenising nozzle according to the invention is suitable for example for the production of emulsions, such as foodstuff emulsions, emulsions of, for example, pharmaceutical or phytosanitary active substances, or chemical emulsions, for example for applications in photography, for building materials, coatings, adhesives and for the production of suspensions. The homogenising nozzle is also suitable for performing two-phase reactions requiring a phase interface, for example nitrations, hydroformulations or telomerisations or for performing monophasic reactions in which it is vital to ensure rapid mixing of two or more components immediately they are combined.

The present invention also provides a process for the production of a two-component coating mixture by mixing two coating components using the homogenising nozzle according to the invention. In particular, it is possible, using the homogenising nozzle according to the invention, to perform a process for the production of an aqueous two-component polyurethane coating emulsion by mixing at least one aqueous binder dispersion comprising isocyanate-reactive groups and a polyisocyanate.

In a first embodiment of the process, the polyisocyanate is supplied via the first inlet and the binder dispersion via the second inlet. In a second embodiment, the first and the second component are supplied in the reverse manner, i.e. the binder dispersion is supplied via the first inlet, the polyisocyanate via the second inlet.

According to the invention, it is also possible to use any binders and crosslinking components hitherto used for two-component polyurethane coatings, as are known, for example, from EP-A 358 979, EP-A 496 205, EP-A 469 389, EP-A 520 266, EP-A 540 985, EP-A 542 105, EP-A 543 228, EP-A 548 669, EP-A 562 282 and EP-A 583 728.

Compounds suitable as an aqueous binder dispersion comprising isocyanate-reactive hydrogen atoms are, for example, polyacrylates, polyesters, urethane-modified polyesters, polyethers, polycarbonates or polyurethanes, in particular those with a molecular weight of 1000 to 10000 g/mol. Hydroxyl groups are preferably used as the isocyanate-reactive groups. The binder resins are used as aqueous dispersions.

Any desired organic polyisocyanates which have aliphatically, cycloaliphatically, araliphatically and/or aromatically attached free isocyanate groups and are liquid at room temperature, are suitable as the polyisocyanate component. The polyisocyanate component should in general have a viscosity of 20 to 1000 mPa·s, preferably of at most 500 mPa·s. Higher viscosity polyisocyanates may, however, also be used if the viscosity of the polyisocyanate component is reduced by an appropriate solvent content.

The polyisocyanates used are preferably those having exclusively aliphatically and/or cycloaliphatically attached isocyanate groups with an average NCO functionality of between 2.2 and 5.0 and a viscosity of 50 to 500 mPa·s at 23° C.

According to the invention, hydrophilised polyisocyanates with aliphatically and/or cycloaliphatically attached isocyanate groups known from the prior art may also be used alone or in proportions. Examples of known hydrophilised polyisocyanates are polyether-modified polyisocyanates, polyisocyanates which contain chemically attached carboxyl groups or polyisocyanates containing sulfonate groups.

The conventional additives and modifiers known in coatings chemistry may furthermore be used.

After emerging from the homogenising nozzle, the coating emulsion obtained by the process according to the invention is supplied as immediately as possible to a suitable application apparatus, for example an atomising nozzle.

The volumetric flow rates of the first and second components are in each case preferably in the range from 1 to 100 l/h, particularly preferably from 3 to 60 l/h. They may, however, also be in the range from 0.01 to 10000 l/h.

The pressure preferably amounts to 0.1 to 100 bar, particularly preferably to 0.1 to 50 bar, very particularly preferably to 1 to 25 bar. The pressure is the dispersion pressure of an individual component, which is defined as the difference between the input pressure of a component and the pressure of the mixture after emerging from the homogenising nozzle.

The use according to the invention of the homogenising nozzle according to the invention for the production of an aqueous two-component polyurethane coating emulsion is distinguished in that finely divided emulsions are obtained at relatively low pressures of as low as less then 50 bar without involving the formation of a pre-emulsion. Accordingly, unlike in the production of coating emulsions according to WO 01/05860 or WO 01/05517, a second upstream nozzle is not required to produce a pre-emulsion. This reduces plant and equipment costs because only one nozzle need be provided and smaller dimensions are possible.

Furthermore, constant quality of the coating emulsion can be achieved with a fluctuating flow rate and at lower pressures in comparison with the prior art. On the other hand, pressure may be controlled at a constant flow rate.

The present invention further provides a substrate which is coated with a coating layer based on at least one aqueous two-component polyurethane coating emulsion which has been produced by the process according to the invention.

The coating emulsions produced by the process according to the invention are suitable for any areas of application requiring aqueous paint and coating systems which must meet elevated requirements for resistance and optical quality, for example for coating inorganic building material surfaces, for coating and sealing wood and derived timber products, for coating metallic surfaces (metal coating), for coating and sealing various plastics surfaces (plastics coating) and for high gloss coatings.

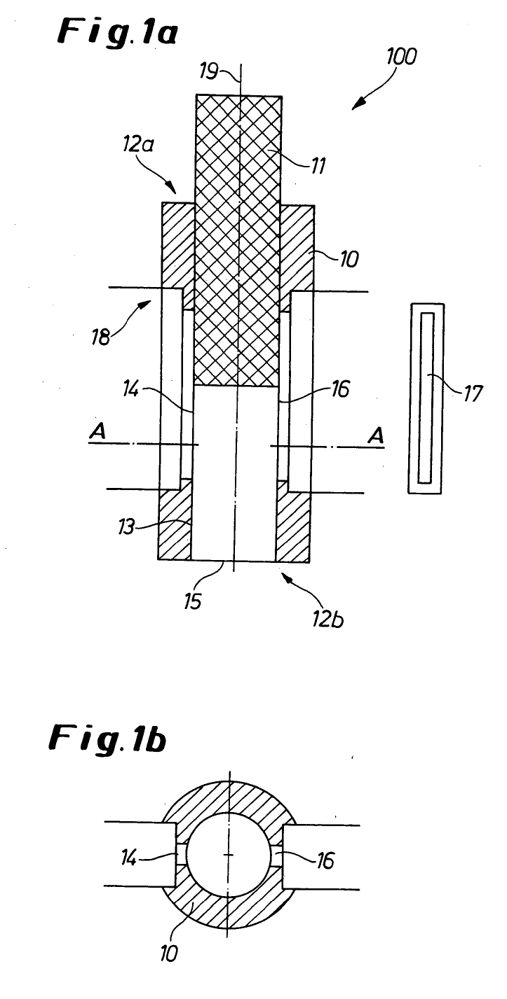

FIG. 1a shows a first embodiment of the homogenising nozzle 100 according to the invention. The casing 10 is cylindrical with a longitudinal axis, which is indicated in FIG. 1a by a dash-dotted line 19. The casing 10 comprises a first end 12a, in the region of which the piston 11 is mounted. The piston 11 is mobile in the casing 10 along the longitudinal axis. Opposite the first end 12a, there is the second end 12b, which is also described as the free end. The side wall 13 of the casing 10 comprises a first inlet 14, which takes the form of a slot 17. Opposite the first inlet 14, there is an outlet 16, which likewise takes the form of a slot 17. The slots 17 of the first inlet and of the outlet are arranged along the longitudinal axis of the casing 10, such that the free cross-sections of the slots can be varied by the position of the piston 11. In a region 18 around the slots 17, the casing wall 13 is thinner than in the other regions of the casing 10. The depth of the slots 17 corresponds to the thickness of the casing wall 14 in this region 18. A second inlet 15 is provided in the region of the free end 12b of the casing 10. Due to the arrangement of the second inlet 15 in the bottom 12b of the casing, the free cross-section of the second inlet 15 cannot be varied by the position of the piston 11.

It can be seen from FIG. 1b that, in the embodiment shown, the first inlet 14 and the outlet 16 are arranged diametrically opposite one another. It may moreover be seen with reference to FIG. 1b that a slot 17 is provided in each as the first inlet 14 and the outlet 16.

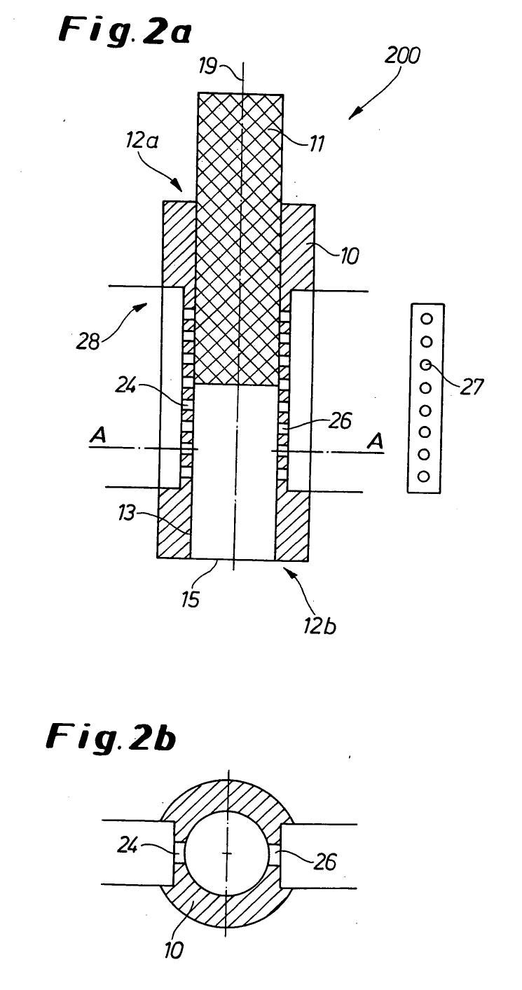

Unlike in FIG. 1a or 1b, in the embodiment of the homogenising nozzle 200 shown in FIG. 2a or 2b, the first inlet 24 and the outlet 26 in each case take the form of a row of bores 27 arranged along the longitudinal axis of the casing 10. A row of holes 27 is here in each case provided for the first inlet 24 and the outlet 26, as can be seen from FIG. 2b. In this embodiment too, the casing wall 13 is thinner in a region 28 around the bores 27 than in the other regions of the casing 10. The depth of the bores 27 corresponds to the thickness of the casing wall 14 in this region 28.

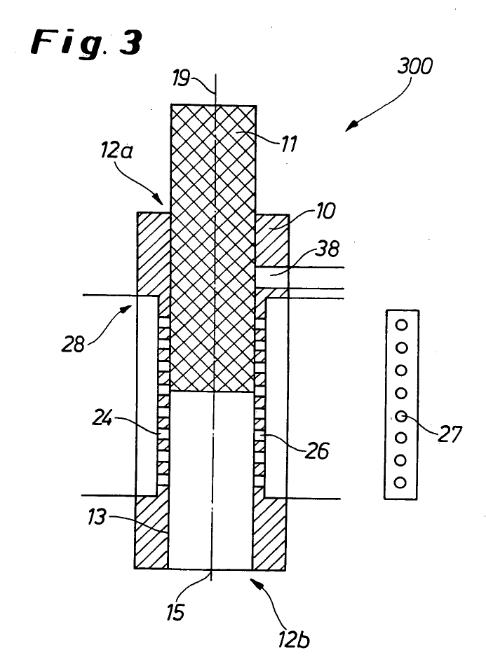

The embodiment of the homogenising nozzle 300 shown in FIG. 3 is similar to the embodiment from FIG. 2a or 2b, but is however additionally provided with a flushing bore 38. The flushing bore 38 is arranged in the side wall 13 of the casing 10. The position of the flushing bore 38 is selected such that the flushing bore 38 is only opened on retraction of the piston 11 after the first inlet 24 and the outlet 26 have been opened. When the piston 11 is retracted, the first inlet 24 and the outlet 26 are thus opened first, before the flushing bore 38 is opened.

### EXAMPLES

### Example 1

### Comparative Example

The following formulation is selected for the Example:

As the aqueous binder dispersion comprising isocyanate-reactive hydrogen atoms:
48.3 wt. % of an OH-functional polyacrylate dispersion with a non-volatile content (DIN EN ISO 3251) of approx. 46 wt. %, a viscosity (23° C., DIN EN ISO 3219) of at most 1500 mPa·s and an OH content, relative to solid resin, of 4.5 wt. %
7.5 wt. % of an OH-functional polyurethane dispersion with a non-volatile content (DIN EN ISO 3251) of approx. 45 wt. %, a viscosity (23° C., DIN EN ISO 3219) of at most 1200 mPa·s and an OH content, relative to solid resin, of 3.8 wt. %
0.3 wt. % of Baysilone® coating additive 3739 (Borchers GmbH, Germany)
0.1 wt. % of Baysilone® coating additive 3738 (Borchers GmbH, Germany)
13.8 wt. % of distilled water.

As the polyisocyanate:
18.0 wt. % of a polyisocyanate containing isocyanurate groups based on 1,6-diisocyanatohexane (HDI) with an NCO content of 23.2%, an average NCO-functionality of 3.2 (according to gel permeation chromatography), a content of monomeric HDI of less than 0.25% and a viscosity of 1200 mPa·s (23° C.)
1.7 wt. % of Tinuvin® 1130 (Ciba Spezialitätenchemie GmbH, Germany), 50% in Rhodiasolv® RP DE (Brenntag GmbH, Germany)
0.9 wt. % of a 50 wt. % solution of Tinuvin® 292 (Ciba Spezialitätenchemie GmbH) in Rhodiasolv RP DE
9.4 wt. % of cosolvent Rhodiasolv RP DE.

A pre-emulsion was produced from the aqueous binder dispersion and the polyisocyanate with a mixing device based on a rotor-stator system. A two-component polyurethane dispersion was produced by passing this pre-emulsion through a jet disperser known from DE 19510651 A with a 3-head piston pump at different pressures (=differential pressure by means of the jet disperser). The jet disperser here had 2 nozzle bores of 0.4 mm in diameter.

The aqueous two-component polyurethane dispersions produced in this manner were used in the following investigations, based on DIN 53230, to evaluate dispersion and coating quality:

Test A: A film of the coating emulsion was deposited on a glass sheet to a wet film thickness of 90 μm. Transparency, snow and specks of the wet film were rated from 0 to 5 by transmitted light inspection (0=very good dispersion quality, i.e. film is completely transparent, no specks, no snow; 5=very poor film dispersion quality, film is milky and/or has lots of specks/snow).

Test B: The aqueous two-component polyurethane dispersion knife coated onto the glass sheet was cured for 30 minutes at 130° C. Film appearance was rated from 0 to 5 (0=very good film appearance, i.e. film is completely transparent, no specks, no snow; 5=very poor film appearance, film has lots of specks/snow).

### Example 2

### Comparative Example

The following formulation is selected for the Example:

As the aqueous binder dispersion comprising isocyanate-reactive hydrogen atoms:
51.5 wt. % of an OH-functional polyacrylate dispersion with a non-volatile content (DIN EN ISO 3251) of approx. 46 wt. %, a viscosity (23° C., DIN EN ISO 3219) of at most 1500 mPa·s and an OH content, relative to solid resin, of 4.5 wt. %
8.1 wt. % of an OH-functional polyurethane dispersion with a non-volatile content (DIN EN ISO 3251) of approx. 45 wt. %, a viscosity (23° C., DIN EN ISO 3219) of at most 1200 mPa·s and an OH content, relative to solid resin, of 3.8 wt. %
0.3 wt. % of Baysilone® coating additive 3739 (Borchers GmbH, Germany)
0.1 wt. % of Baysilone® coating additive 3738 (Borchers GmbH, Germany)
110.0 wt. % of distilled water.

As the polyisocyanate:
19.2 wt. % of a polyisocyanate containing isocyanurate groups based on 1,6-diisocyanatohexane (HDI) with an NCO content of 23.2%, an average NCO-functionality of 3.2 (according to gel permeation chromatography), a content of monomeric HDI of less than 0.25% and a viscosity of 1200 mPa·s (23° C.)
1.9 wt. % of Tinuvin® 1130 (Ciba Spezialitätenchemie GmbH, Germany), 50% in Rhodiasolv® RP DE (Brenntag GmbH, Germany)
0.9 wt. % of a 50 wt. % solution of Tinuvin® 292 (Ciba Spezialitätenchemie GmbH) in Rhodiasolv RP DE
8.0 wt. % of cosolvent Rhodiasolv RP DE.

A pre-emulsion was produced from the aqueous binder dispersion and the polyisocyanate with a mixing device based on a rotor-stator system. A two-component polyurethane dispersion was produced by passing this pre-emulsion through a jet disperser known from DE 19510651 A with a 3-head piston pump at different pressures (=differential pressure by means of the jet disperser). The jet disperser here had 2 nozzle bores of 0.4 mm in diameter.

The aqueous two-component polyurethane dispersions were subjected to tests A and B described in Example 1.

### Example 3

### Exemplary Embodiment

The following formulation is selected for the Example:

As the aqueous binder dispersion comprising isocyanate-reactive hydrogen atoms:
48.3 wt. % of an OH-functional polyacrylate dispersion with a non-volatile content (DIN EN ISO 3251) of approx. 46 wt. %, a viscosity (23° C., DIN EN ISO 3219) of at most 1500 mPa·s and an OH content, relative to solid resin, of 4.5 wt. %
7.6 wt. % of an OH-functional polyurethane dispersion with a non-volatile content (DIN EN ISO 3251) of approx. 45 wt. %, a viscosity (23° C., DIN EN ISO 3219) of at most 1200 mPa·s and an OH content, relative to solid resin, of 3.8 wt. %
0.3 wt. % of Baysilone® coating additive 3739 (Borchers GmbH, Germany)
0.1 wt. % of Baysilone®-coating additive 3738 (Borchers GmbH, Germany)
8.4 wt. % of distilled water.

As the polyisocyanate:
18.0 wt. % of a polyisocyanate containing isocyanurate groups based on 1,6-diisocyanatohexane (HDI) with an NCO content of 23.2%, an average NCO-functionality of 3.2 (according to gel permeation chromatography), a content of monomeric HDI of less than 0.25% and a viscosity of 1200 mPa·s (23° C.)
1.7 wt. % of Tinuvin® 1130 (Ciba Spezialitätenchemie GmbH, Germany), 50% in Rhodiasolv® RP DE (Brenntag GmbH, Germany)
0.9 wt. % of a 50 wt. % solution of Tinuvin® 292 (Ciba Spezialitätenchemie GmbH) in Rhodiasolv RP DE
8.4 wt. % of cosolvent Rhodiasolv RP DE.

A two-component polyurethane dispersion was produced by supplying the aqueous binder dispersion and the polyisocyanate to an embodiment of the homogenising nozzle according to the invention. The piston was of a diameter of 6 mm. The aqueous binder dispersion was supplied through the second inlet, the second inlet being arranged in the bottom of the casing. The second inlet consisted of a bore of 6 mm in diameter. The polyisocyanate was supplied through the first inlet, the first inlet consisting of a slot of 7 mm in length, 0.1 mm in width and 1 mm in depth. The homogenised mixture was discharged through the outlet opposite the first inlet, the outlet taking the form of a slot of 10.5 mm in length, 0.2 mm in width and 1 mm in depth. The slots of the first inlet and the outlet were arranged such that the centre of the inlet slot and the centre of the outlet slot were located at an identical position along the longitudinal axis of the casing. Overall throughput was 42 l/h.

The aqueous two-component polyurethane dispersions were subjected to tests A and B described in Example 1.

Table 1 shows the test parameters and results for the Exemplary Embodiment and the Comparative Examples. Line 1 shows the pressure drop through the jet disperser, which is defined as the pressure difference between the inlet and outlet of the jet disperser. The pressure of the polyisocyanate and of the binder dispersion in lines 2 and 3 respectively should be taken to be the pressure difference between the inlet of the respective components and outlet of the homogenised mixture of the two components.

TABLE 1

| | Ex. 1 | Ex. 1 | Ex. 1 | Ex. 2 | Ex. 3 |
|---|---|---|---|---|---|
| | Test 1 | Test 2 | Test 3 | Test 4 | Test 5 |
| Jet disperser | 10 | 15 | 20 | 45 | — |
| pressure [bar] | | | | | |
| Polyisocyanate | — | — | — | — | 17 |
| pressure [bar] | | | | | |
| Binder dispersion | — | — | — | — | 16 |
| pressure [bar] | | | | | |
| Test A | 5 | 3-4 | 2 | 1 | 1 |
| Test B | 1-2 | 1 | 0-1 | 0 | 0 |

### Example 4

### Comparative Example

For the following Exemplary Embodiments and Comparative Examples, the model emulsion selected was an emulsion prepared from an oil component comprising constituents 1-3 and an aqueous component comprising constituent 4 corresponding to the following formulation:

| No. | Constituents | Proportion [wt. %] |
|---|---|---|
| 1 | Paraffin oil W15 | 40 |
| 2 | Tween ® 80 (polyethylene sorbitan | 6.7 |
| | monooleate, Carl Roth GmbH, Karlsruhe) | |
| 3 | Span 80 (sorbitan monooleate, Carl Roth | 3.3 |
| | GmbH, Karlsruhe) | |
| 4 | Distilled water | 50 |

An oil-in-water pre-emulsion was produced from the oil component and the aqueous component with a mixing device based on a rotor-stator system. The finished emulsion was produced by passing this pre-emulsion through a jet disperser known from DE 19510651 A at different pressures (=differential pressure by means of the jet disperser). The jet disperser here had one nozzle bore of 0.65 mm in diameter.

In order to evaluate the quality of the resultant emulsions, they were investigated with regard to their particle size using a laser diffraction instrument (from Malvern). The 50% median value of the frequency distribution (d₅₀) was used as the criterion. In this case, emulsion quality is greater, the smaller is the particle size (d₅₀).

### Example 5

### Exemplary Embodiment

Formulation according to Example 4.

The oil component and the aqueous component were supplied to an embodiment of the homogenising nozzle according to the invention with a cylindrical casing. The piston had a diameter of 3 mm. The aqueous component was supplied through the second inlet in the bottom of the casing. The second inlet consisted of a bore of 3 mm in diameter. The oil component was supplied through the first inlet with a slot of 7 mm in length, 0.07 mm in width and 1 mm in depth. The homogenised mixture was discharged through the outlet slot opposite the first inlet slot, the outlet taking the form of a slot of 10.5 mm in length, 0.1 mm in width and 1 mm in depth. The slots were arranged such that the centre of the inlet slot and the centre of the outlet slot were located at an identical position along the longitudinal axis of the casing. The resultant aqueous oil-in-water emulsions were subjected to the particle size analysis described in Example 4.

Table 2 shows the test parameters and results for the Exemplary Embodiments and Comparative Examples.

TABLE 2

| | Ex. 4 | Ex. 4 | Ex. 5 | Ex. 5 | Ex. 5 |
|---|---|---|---|---|---|
| | Test 11 | Test 12 | Test 13 | Test 14 | Test 15 |
| Jet disperser | 12 | 50 | — | — | — |
| pressure [bar] | | | | | |
| Oil pressure [bar] | — | — | 10 | 25 | 25 |
| Water pressure | — | — | 3 | 7 | 7 |
| [bar] | | | | | |
| Overall | — | — | 40 | 40 | 20 |
| throughput [l/h] | | | | | |
| d₅₀ [μm] | 3.1 | 2.1 | 1.9 | 1.3 | 1.6 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A homogenising nozzle comprising a casing, a piston arranged displaceably along the longitudinal axis of the casing, a first inlet for a first component, a second inlet for a second component and an outlet for a homogenised mixture of the first and second components, wherein the first inlet and the outlet are arranged along the longitudinal axis of the casing in such a manner that, by displacing the piston, the free cross-section of the first inlet and the free cross-section of the outlet may be varied.

2. A homogenising nozzle according to claim 1, wherein the cross-section of the first inlet is 8·10⁻¹¹ to 8·10⁻³ m².

3. A homogenising nozzle according to claim 1, wherein the cross-section of the outlet is 8·10⁻¹¹ to 8·10⁻³ m².

4. A homogenising nozzle according to claim 1, wherein the first inlet and/or the outlet consist(s) of a plurality of bores arranged along the longitudinal axis.

5. A homogenising nozzle according to claim 4, wherein the number of bores of the first inlet and/or of the outlet in each case amounts to 1 to 10000.

6. A homogenising nozzle according to claim 4, wherein the diameter of the bores of the first inlet and/or of the outlet amounts to 10 to 1000 μm.

7. A homogenising nozzle according to claim 1, wherein the first inlet and/or the outlet consist(s) of at least one slot arranged along the longitudinal axis.

8. A homogenising nozzle according to claim 7, characterised in that the slot has a slot length of 1 to 50 mm.

9. A homogenising nozzle according to claim 7, wherein the slot has a slot width of 10 to 1500 μm.

10. A homogenising nozzle according to claim 4 or claim 7, wherein the depth of the bores or the slot of the first inlet and/or of the outlet amounts to 0.5 times to 20 times the width.

11. A homogenising nozzle according to claim 1, wherein the second inlet is an orifice with a diameter of 0.5 to 10 mm, particularly preferably of 3 to 6 mm.

12. A process for the production of a two-component coating mixture by mixing two coating components using a homogenising nozzle according to claim 1.

13. A process according to claim 12, wherein the two-component coating mixture is an aqueous two-component polyurethane coating emulsion based on at least one aqueous binder dispersion comprising isocyanate-reactive groups and a polyisocyanate.

14. A process according to claim 13, wherein the polyisocyanate is supplied through the first inlet and the binder dispersion through the second inlet.

15. A process according to claim 13, wherein the volumetric flow rates of the binder dispersion and of the polyisocyanate in each case amount to 1 to 100 l/h.

16. A process according to claim 13, wherein the pressure amounts to 0.1 to 100 bar.

17. A substrate coated with a coating layer based on at least one aqueous two-component polyurethane coating emulsion produced by a process according to claim 13.

18. The homogenizing nozzle of claim 1, wherein the depth of the first inlet and/or of the outlet amounts to 1 to 10 times the width.

19. A process according to claim 13, wherein the volumetric flow rates of the binder dispersion and of the polyisocyanate in each case amount to 3 to 60 l/h.

20. A process according to claim 13, wherein the pressure amounts to 0.1 to 50 bar.
